(19) United States
(12) Patent Application Publication
(10) Pub. No.: US 2025/0083603 A1
(43) Pub. Date: Mar. 13, 2025

(54) SENSOR HOUSING CONFIGURED FOR MOUNTING TO A VEHICLE ROOF

(71) Applicant: TuSimple, Inc., SAN DIEGO, CA (US)

(72) Inventors: Raymond Alan THOMAS, San Diego, CA (US); Juexiao NING, San Jose, CA (US); Qiwei LI, San Diego, CA (US); Todd B. SKINNER, Orlando, FL (US); Christopher Luis HERNANDEZ, San Diego, CA (US); Graham Philip TAYLOR, San Diego, CA (US)

(21) Appl. No.: 18/830,195

(22) Filed: Sep. 10, 2024

Related U.S. Application Data
(60) Provisional application No. 63/582,364, filed on Sep. 13, 2023.

(51) Int. Cl. B60R 1/27; B60R 11/00; B60R 11/04

(52) U.S. Cl. CPC B60R 1/27; B60R 11/04; B60R 2011/004

(57) ABSTRACT

A sensor housing is provided that is configured to be mounted to a roof of a vehicle. The sensor housing includes a frame defining a plurality of cavities and a plurality of windows opening into respective cavities. The sensor housing also includes a plurality of sensors, at least some of which are disposed within the respective cavities defined by the frame. The sensors disposed within the respective cavities are oriented relative to the frame such that fields of view of the sensors that are disposed within the respective cavities defined by the frame are directed through the windows that open into the respective cavities. At least one of the plurality of sensors may include a camera mounted to the frame so as to be exterior to the vehicle and oriented such that a field of view of the camera is directed into a cabin of the vehicle.

### CROSS-REFERENCE TO RELATED APPLICATIONS

This application claims priority to and the benefit of U.S. Provisional Application No. 63/582,364, filed on Sep. 13, 2024. The aforementioned application of which is incorporated herein by reference in its entirety.

### TECHNICAL FIELD

An example embodiment relates generally to a sensor housing and, more particularly, to a sensor housing configured to securely position a plurality of sensors to the roof of a vehicle, such as an autonomous vehicle.

### BACKGROUND

A vehicle may include cameras or other sensors mounted or installed on the vehicle, such as on the roof of the vehicle. These sensors may serve various purposes including the provision of input for a vehicular security system, the facilitation of driver assistance systems and/or the facilitation of autonomous driving of the vehicle. Although the cameras and other sensors may be individually mounted on the vehicle, such as on the roof of the vehicle, these individually mounted sensors may draw unwanted attention and may diminish the aerodynamic profile of the vehicle.

Thus, sensor housings have been developed that are configured to house the cameras and other sensors. These sensor housings are configured to be mounted to the roof of a vehicle. While sensor housings provide for a more aerodynamic profile and reduce the visibility of the cameras and other sensors to third parties, sensor housings may detract from the appearance of the vehicle. For example, sensor housings may appear to be an aftermarket addition to a vehicle that diminishes the overall appearance of the vehicle by failing to fit or otherwise be consistent with the overall design of the vehicle.

### BRIEF SUMMARY

A sensor housing is provided that is configured to be mounted to the roof of a vehicle. The sensor housing securely houses a plurality of sensors within a frame that is more consistent with the overall vehicle design and that dampens the vibration from the vehicle to the sensors, while continuing to limit the aerodynamic impact of the sensor housing. As such, the plurality of sensors housed by the sensor housing can capture information that may be utilized for a variety of purposes including the support of driving operations, such as autonomous driving operations. In one example embodiment, the sensor housing includes a camera mounted to the frame of the sensor housing so as to be exterior to the vehicle and oriented such that the field of view of the camera is directed into the cab of the vehicle. Thus, the sensor housing of this example embodiment can assist not only with respect to driving operations by monitoring the performance of a driver, but also by providing information for a security system in the event that an unauthorized person enters the cabin of the vehicle.

In an example embodiment, a sensor housing is provided that is configured to be mounted to the roof of a vehicle. The sensor housing of this example embodiment includes a frame defining a plurality of cavities and defining a plurality of windows opening into respective cavities of the plurality of cavities. The sensor housing also includes a plurality of sensors. At least some of the sensors are disposed within the respective cavities defined by the frame. The sensors disposed within the respective cavities defined by the frame are oriented relative to the frame such that fields of view of the sensors that are disposed within the respective cavities defined by the frame are directed through the windows that open into the respective cavities. In this example embodiment, at least one of the plurality of sensors includes a camera mounted to the frame so as to be exterior to the vehicle and oriented such that a field of view of the camera is directed into a cabin of the vehicle. As such, the sensor housing of this example embodiment provides enhanced situational awareness of the cabin of the vehicle, such as for security purposes, driver monitoring or the like.

The frame of an example embodiment includes a medial section and first and second side sections extending both outwardly and rearwardly from opposite sides of the medial section. The camera of this example embodiment that is oriented such that the field of view is directed into the cabin of the vehicle is mounted to the medial section of the frame.

The frame of an example embodiment also defines a channel extending between the plurality of cavities and configured to house electrical wiring for the plurality of sensors and/or plumbing for directing cleaning fluid to the plurality of sensors. The frame of an example embodiment further defines one or more rear windows opening through a rear surface of the frame and into respective cavities of the plurality of cavities, thereby providing access to the interior of the frame. In an example embodiment, the sensor housing also includes one or more base mounts configured to mount the frame to the roof of the vehicle. A respective base mount of the one or more base mounts includes a resilient gasket disposed on the roof of the vehicle and a base mount block positioned upon the resilient gasket and connected to the roof of the vehicle. The frame of an example embodiment is formed of a composite material. In an example embodiment, the frame is configured to be disposed within a wind deflector on the roof of the vehicle. In this example embodiment, the plurality of windows defined by the framework are configured to be aligned with respective openings defined by the wind deflector. The plurality of sensors of an example embodiment are in communication with a compute unit that is disposed within a wind deflector on the roof of the vehicle.

In another example embodiment, a sensor housing is provided that is configured to be mounted to the roof of a vehicle. The sensor housing of this example embodiment includes a frame defining a plurality cavities and defining a plurality of windows opening into respective cavities of the plurality of cavities. The plurality of cavities are configured to house corresponding sensors. The sensor housing also includes one or more base mounts configured to mount the frame to the roof of the vehicle and one or more side mounts configured to mount the frame to a side facing surface of the vehicle.

The one or more side mounts of an example embodiment include first and second side mounts configured to mount the frame to opposite side-facing surfaces of the vehicle. In this example embodiment, the sensor housing may also include a support rod extending through the cabin of the vehicle between the first and second side mounts. The sensor housing of this example embodiment may also include a camera mounted to the support rod so as to have a field of view directed into the cabin of the vehicle.

The frame of an example embodiment includes a medial section and first and second side sections extending both outwardly and rearwardly from opposite sides of the medial section. In an example embodiment, the frame further defines a channel extending between the plurality of cavities and configured to house the electrical wiring for the sensors and/or the plumbing for directing cleaning fluid to the sensors. The frame of an example embodiment further defines one or more rear windows opening through a rear surface of the frame and into respective cavities of the plurality of cavities. In an example embodiment, a respective base mount of the one or more base mounts includes a resilient gasket disposed on the roof of the vehicle and a base mount block positioned upon the resilient gasket and connected to the roof of the vehicle. The frame of an example embodiment is formed of a composite material. In an example embodiment, the frame is configured to be disposed within a wind deflector on the roof of the vehicle. In this example embodiment, the plurality of windows defined by the frame are configured to be aligned with respective openings defined by the wind deflector. The plurality of sensors of an example embodiment are in communication with a compute unit that is disposed within a wind deflector on the roof of the vehicle.

In a further example embodiment, a sensor housing is configured to be mounted to the roof of a vehicle. The sensor housing includes a frame defining a plurality of cavities and defining a plurality of windows opening into respective cavities of the plurality of cavities. The plurality of cavities are configured to house corresponding sensors. The frame includes upper and lower surfaces and a plurality of internal support stiffeners extending between the upper and lower surfaces. The internal support stiffeners include a plurality of tabs and the upper and lower services define a plurality of corresponding slots for receiving and being welded to respective tabs such that the frame is a single weldment.

The frame of an example embodiment includes a medial section and first and second side sections extending both outwardly and rearwardly from opposite sides of the medial section. In an example embodiment, the frame also defines a channel extending between the plurality of cavities and configured to house electrical wiring for the sensors and/or plumbing for directing cleaning fluid to the sensors. In an example embodiment, the frame further defines one or more rear windows opening through a rear surface of the frame and into respective cavities of the plurality of cavities. The sensor housing of an example embodiment also includes one or more base mounts configured to mount the frame to the roof of the vehicle. A respective base mount of the one or more base mounts includes a resilient gasket disposed on the roof of a vehicle and a base mount block positioned upon the resilient gasket and connected to the roof of the vehicle. In an example embodiment, the frame is configured to be disposed within the wind deflector on the roof of the vehicle. In this example embodiment, the plurality of windows defined by the frame are configured to be aligned with respective openings defined by the wind deflector.

### BRIEF DESCRIPTION OF THE FIGURES

For a more complete understanding of this disclosure, reference is now made to the following brief description, taken in connection with the accompanying drawings and detailed description, wherein like referenced numerals represent like parts.

FIG. 1 is a perspective view of a vehicle having a sensor housing in accordance with an example embodiment mounted to the roof of the vehicle;

FIG. 2 is a perspective view of a vehicle having a sensor housing in accordance with an example embodiment mounted within a wind deflector on the roof of the vehicle;

FIG. 3 is a perspective view of the frame of a sensor housing in accordance with an example embodiment of the present disclosure that is mounted to the roof a vehicle with the exterior cover having been removed for purposes of illustration;

FIG. 4A is a perspective view of a portion of the frame including a plurality of sensors within respective cavities in accordance with an example embodiment of the present disclosure;

FIG. 4B is a perspective view of a frame that depicts the rear surface and the rear windows defined therein in accordance with an example embodiment of the present disclosure;

FIG. 5A is a top view of a portion of a frame depicting a channel extending through the frame in accordance with an example embodiment of the present disclosure;

FIG. 5B is a schematic representation of a frame depicting a channel extending through the frame in accordance with an example embodiment of the present disclosure;

FIG. 6A is a perspective view of a base mount that is configured to mount the frame to the roof of the vehicle in accordance with an example embodiment of the present disclosure;

FIG. 6B is a perspective view of a base mount that is configured to mount the frame to the roof of the vehicle in accordance with another example embodiment of the present disclosure;

FIG. 7 is a side view of a connector for attaching the frame to a base mount in accordance with an example embodiment of the present disclosure;

FIG. 8 is a perspective view of a side mount in accordance with an example embodiment of the present disclosure;

FIG. 9 is a perspective view of a sensor housing that supports an external camera in accordance with an example embodiment of the present disclosure;

FIG. 10 is a sensor housing having a support rod and a camera mounted thereon to capture an image of the cabin in accordance with an example embodiment of the present disclosure;

FIG. 11 is an exploded perspective view illustrating the tab and slot design by which internal support stiffeners engage corresponding slots defined by the frame in accordance with an example embodiment;

FIG. 12 illustrates the engagement of a tab of an internal stiffener with a slot defined by a frame in accordance with an example embodiment;

FIG. 13 illustrates a block diagram of a control subsystem in accordance with some embodiments discussed herein;

FIG. 14 illustrates a block diagram of a system for autonomous driving operations in accordance with some embodiments discussed herein; and

FIG. 15 illustrates a diagram of an in-vehicle control computer included in an AV in accordance with some embodiments discussed herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

A sensor housing is provided in accordance with an example embodiment that is configured to be mounted to the roof of a vehicle. The sensor housing is configured to securely retain a plurality of sensors that may be utilized for a variety of purposes. For example, the sensors may facilitate autonomous or semi-autonomous driving of the vehicle. Alternatively, the sensor may provide information that may be utilized by a driver of a manually driven vehicle, such as in conjunction with various driver assistance features. Further, the sensors may be utilized in conjunction with a security application intended to protect the vehicle. Regardless of the application for which the sensors are deployed, the sensor housing securely mounts the sensors such that the sensors have the desired fields of view while being incorporated into the overall design of the vehicle so as not to diminish the appearance of the vehicle and not to draw unwanted attention. In some embodiments, the sensor housing is also configured to facilitate the routing of the electrical wiring and/or plumbing that extend to the sensors in an efficient and controlled manner.

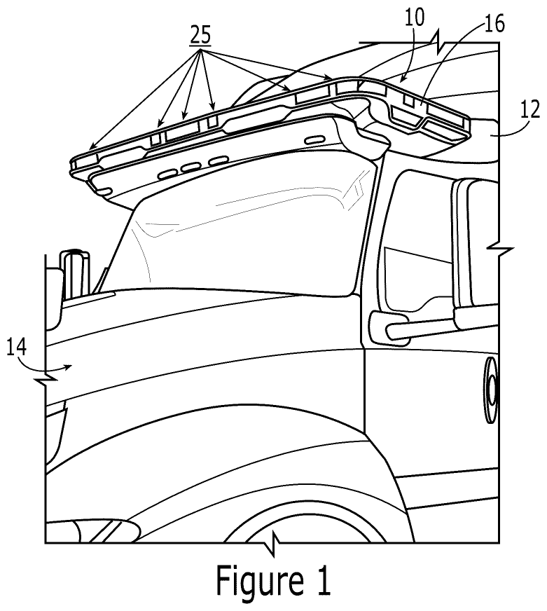

Referring now to FIG. 1, a sensor housing 10 that is mounted to the roof 12 of a vehicle 14 is depicted. In the illustrated embodiment, the vehicle is a tractor of a tractor trailer and the sensor housing is mounted to the flat roof of the tractor trailer above the cabin. However, the vehicle may be any of a wide variety of types of vehicles including trucks, automobiles or the like. In the embodiment of FIG. 1, the sensor housing is disposed within a cover 16, such as an external visor or facia of a truck. The cover and the sensor housing may be connected or otherwise integrated with one or more fasteners. In some embodiments, the cover is also secured to the roof of the vehicle, such as by one or more additional fasteners. The cover not only serves to further protect the sensor housing and the sensors mounted therein, but also can be configured to be compatible with and consistent with the appearance of the vehicle, thereby improving the overall appearance of the vehicle. Additionally, the cover can have a smooth contour so as to improve or at least avoid negatively impacting the aerodynamic performance of the sensor housing as mounted to the roof of the vehicle.

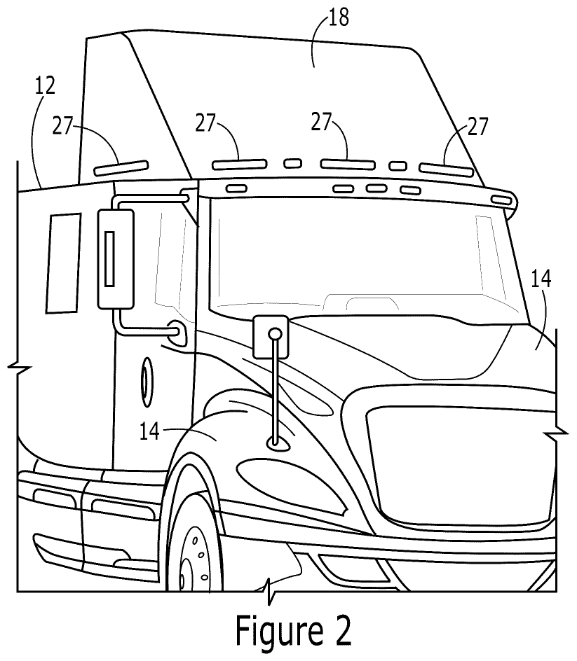

The sensor housing 10 need not be disposed within a cover 16 as shown in FIG. 1. Instead, the sensor housing of another example embodiment can be mounted to the roof 12 of the vehicle 14 without a cover. In other embodiments, the sensor housing may be mounted to the roof of the vehicle so as to be disposed within, such as behind, a wind deflector 18 that is also mounted to the roof of the vehicle, such as shown in FIG. 2. As used herein, a wind deflector generally refers to an air deflector, roof fairing, wind dam or the like. By being disposed within the wind deflector, the appearance of the vehicle remains unaltered and similarly, the aerodynamic performance of the vehicle remains unaltered.

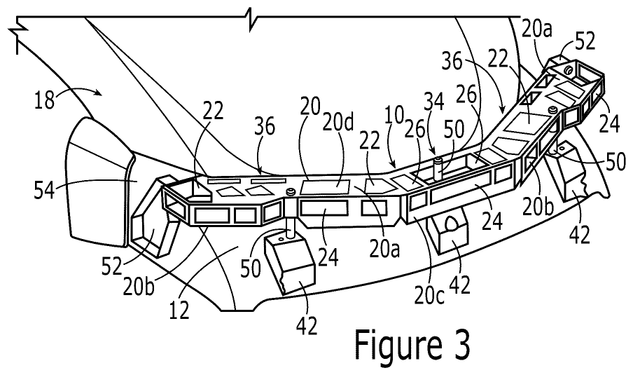

Referring now to FIG. 3, a sensor housing 10 mounted to the roof 12 of a vehicle 14 without a cover is depicted for purposes of illustration. The sensor housing includes a frame 20 defining a plurality of cavities 22 and defining a plurality of windows 24 opening to respective cavities of the plurality of cavities. Although the sensor housing may be configured in various manners, the frame of the sensor housing of FIG. 3 includes upper and lower surfaces 20a, 20b and a plurality of internal support stiffeners 26 extending between the upper and lower surfaces. The sensor housing of FIG. 3 also includes a front surface 20c that defines the windows that open into the cavities and an opposed rear surface 20d that at least partially closes the rear side of the cavities, opposite the plurality of windows. As such, a plurality of cavities are defined by the sensor housing with each cavity defined between the upper and lower surfaces, between the front and rear surfaces and also between a pair of internal support stiffeners disposed on opposite sides of the cavity.

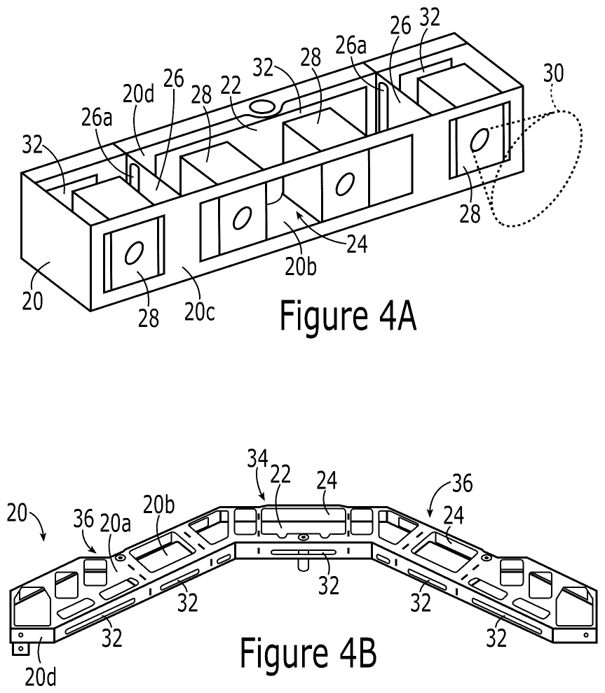

The sensor housing 10 also includes a plurality of sensors 28. At least some of the sensors are disposed within the respective cavities 22 defined by the frame 20. As shown in FIG. 4A which depicts a section of the frame, for example, one, two or more sensors may be disposed in each of the cavities defined by the frame. The sensor housing may include any of a wide variety of different types of sensors. For example, the sensors may include cameras, light detection and ranging (LiDAR) units, infrared detectors and the like. The sensors disposed within the respective cavities defined by the frame are oriented relative to the frame such that the fields of view of the sensors are directed through the windows 24 that open into the respective cavities in which the sensors are disposed. By way of example and as shown in FIG. 4A, a sensor that is disposed within a respective cavity defined by the frame has a field of view 30 that extends outwardly through the window that opens into the respective cavity so as to capture information beyond the vehicle 14, such as in advance of the vehicle in direction of travel, to the left of the vehicle relative to the direction of travel, to the right of the vehicle relative to the direction of travel and/or the like.

In the embodiment in which the sensor housing 10 is disposed within a cover 16 as shown in FIG. 1, the cover defines a plurality of windows 25 through which the fields of view of the sensors 28 carried by the sensor housing extend. As such, the windows defined by the cover may be aligned with the windows 24 defined by the frame 20 that open into the respective cavities 22 in which the sensors are disposed. Similarly, in the embodiment in which the sensor housing is disposed within a wind deflector 18, the wind deflector can also define a plurality of windows 27 through which the fields of view of the sensors carried by the sensor housing extend. Thus, the windows defined by the wind deflector may be aligned with the windows defined by the frame that open into the respective cavities in which the sensors are disposed.

The frame 20 of an example embodiment also defines one or more rear windows 32 that open through the rear surface 20d of the frame and into the respective cavities 22 defined by the frame. See FIGS. 4A and 4B. The rear windows facilitate access to the cavities, such as while the sensors 28 are mounted within the respective cavities. Access to the cavities may be desired for various purposes, such as to facilitate cleaning or to allow for maintenance or repair of sensors and/or the electrical wiring and/or plumbing that extend to the respective sensors, as described below. By permitting access to the respective cavities via the rear windows defined by the rear surface of the frame, the sensors, the electrical wiring and/or the plumbing need not be disassembled in order to maintain the sensor housing 10. Additionally, the access to the cavities that is provided by the rear windows may permit sensors, electrical wiring and/or plumbing to be installed, such as to add or replace a sensor, once the sensor housing is in operation.

Although the frame 20 may be structured in different manners, the frame of the illustrated embodiment includes a medial section 34 and first and second side sections 36 extending outwardly and, in at least some embodiments, rearwardly from opposite sides of the medial section so as to be fanned back from the medial section. Both the medial section and the first and second side sections may define cavities 22 as well as windows 24 that open into respective cavities. As shown in FIGS. 3 and 4B, one or more of the windows open through the front surface 20c of the frame such that the field of view 30 of a sensor 28 that extends through such a window extends in advance of the vehicle 14. In order to provide for different fields of view, however, the frame of an example embodiment, such as the first and second side sections of the frame, may alternatively or additionally define one or more windows opening to the side of the vehicle, such as to the left and to the right of the vehicle, thereby increasing the overall field of view captured by the plurality of sensors mounted within the sensor housing 10. For example, at least some cavities defined by the first and second side sections, such as the lateral-most cavities defined by the first and second side sections, may open through windows that face the side of vehicle.

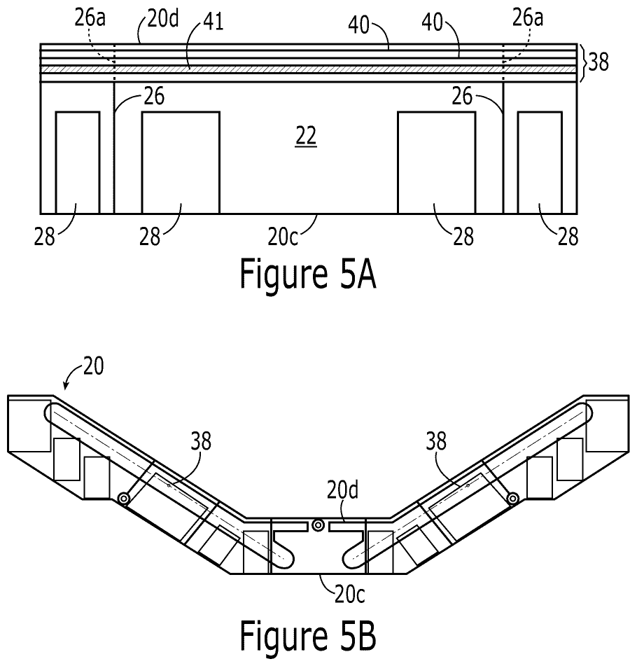

The frame 20 of an example embodiment not only defines a plurality of cavities 22, but also defines a channel 38 extending between the plurality of cavities, as shown in FIGS. 5A and 5B. The channel of the illustrated embodiment extends along the entire frame, such as the entire width of the frame, from the one side surface to the opposing side surface so as to extend between and interconnect all the cavities defined by the frame. However, the channel of other example embodiments may extend between some, but not all, cavities defined by the frame and, as a result, may extend across only a portion of the width of the frame. The channel is continuous and, as a result, is not blocked by the internal support stiffeners 26. In this regard, the internal support stiffeners either do not extend into the channel or, if the internal support stiffeners do extend into the channel, the internal support stiffeners define an opening 26a therethrough that is aligned with the channel and through which the channel extends. See FIG. 4A and also in FIG. 4A which depicts the openings through the internal support stiffeners in dashed lines. The cavities open into the channel and the channel, in turn, opens through the rear windows 32 of this example embodiment, thereby permitting access to a cavity via a rear window and, in turn, the channel.

The channel 38 is configured to house one or both of electrical wiring 40 for the plurality of sensors 28 or plumbing, such as one or more conduits 41, for directing cleaning fluid to the plurality of sensors, as shown in FIG. 5A. In this regard, electrical wiring may extend from the vehicle 14, such as from a controller, a computing unit or the like carried by the vehicle, to the plurality of sensors in order to provide power to and control the operation of the sensors and to receive data collected by the sensors, such as for storage, analysis or the like. As such, a bundle containing a plurality of electrical wires may extend through the channel with at least one electrical wire extending to each different sensor. By way of example, a computing unit (e.g., one or more processors, microcontrollers, and such) of an autonomous vehicle may be positioned on the roof 12 of the vehicle behind and within a wind deflector 18 so as to be in communication via the electrical wires with the sensors without adversely impacting the aerodynamic performance of the vehicle. For example, the advanced driving system (ADS) compute unit may be relocated from within the cab of an autonomous truck to the roof of an autonomous truck and positioned behind and within a wind deflector so as to maintain the aerodynamic performance of the autonomous truck while being in contact with the sensors.

As to the plumbing, one or more of the sensors 28 may be configured to be cleaned in order to maintain the desired performance levels by removing foreign objects that have accumulated on the sensor and that may adversely impact the sensor during operation. In order to allow for cleaning of the sensor, one or more nozzles may be positioned relative to the face of the sensor, such as the front face of the sensor, for dispensing cleaning fluid provided by the plumbing that is carried by the channel. As such, cleaning fluid may be directed through a conduit 41, such as from a reservoir of cleaning fluid maintained by the vehicle 14, to the nozzle in order to be sprayed on the face of the sensor. The cleaning fluid serves to clean the sensor and to remove at least some of the foreign objects from the sensor in order to improve the performance of the sensor. The delivery of the cleaning fluid to the sensors may be controlled, such as by the controller carried by the vehicle.

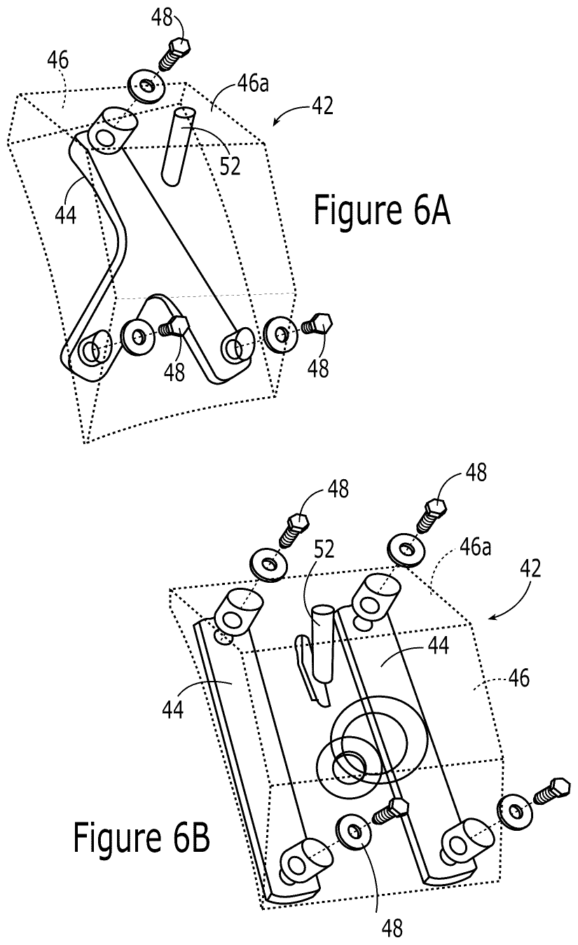

As shown in FIG. 3, the sensor frame 20 is mounted to the roof 12 of the vehicle 14. As such, the sensor housing 10 of an example embodiment includes one or more base mounts 42 that are configured to mount the frame to the roof of the vehicle. The base mounts may be configured in various manners and may be mounted to the roof in various manners, such as magnetically, adhesively or the like. In example embodiments depicted in FIGS. 6A and 6B, however, a base mount includes a resilient gasket 44, such as a rubber gasket, disposed on the roof of the vehicle and a base mount block 46 positioned upon the resilient gasket and removably mechanically connected to the roof of the vehicle with one or more connectors. In this regard, the base mount block and the resilient gasket may define apertures that are aligned with one another and are configured to receive a connector 48, such as a bolt or other type of fastener. The bolts may extend through the apertures defined by the base mount block and the resilient gasket as well as through corresponding openings that defined by the roof of the vehicle and aligned with the corresponding apertures of the base mount block and the resilient gasket. The connectors may be secured within the vehicle, such as by threading a nut onto a corresponding bolt.

The resilient gasket 44 and, as a result, the corresponding pattern of apertures 48 defined by the base mount block 46 and the resilient gasket may be differently embodied. For example, a Y-shaped resilient gasket is depicted in FIG. 6A with apertures defined in each of the legs of the resilient gasket. Alternatively, as shown in FIG. 6B, the base mount 42 may include two or more linear resilient gaskets that define apertures at opposite ends thereof. Regardless of the configuration of the resilient gasket, the base mount block defines apertures that are aligned with the apertures defined by the resilient gasket and, in turn, with corresponding apertures defined by the roof 12 of the vehicle 14.

As shown in FIG. 3, a sensor housing 10 may include a plurality of base mounts 42 spaced apart across the width of the sensor housing. For example, a first base mount may be positioned in the center of the sensor housing and second and third base mounts may be positioned laterally spaced from the first base mount on opposite sides thereof. The base mounts are positioned upon the roof of the vehicle so as to position the sensor housing in the desired orientation relative to the vehicle. In an example embodiment, the sensor housing is positioned so as to have a horizontal orientation and to be facing forward relative to the forward path of travel of the vehicle. As such, the upper surfaces 46a of the base mount blocks 46 upon which the sensor frame 20 is supported are advantageously aligned in a horizontal plane in this example embodiment.

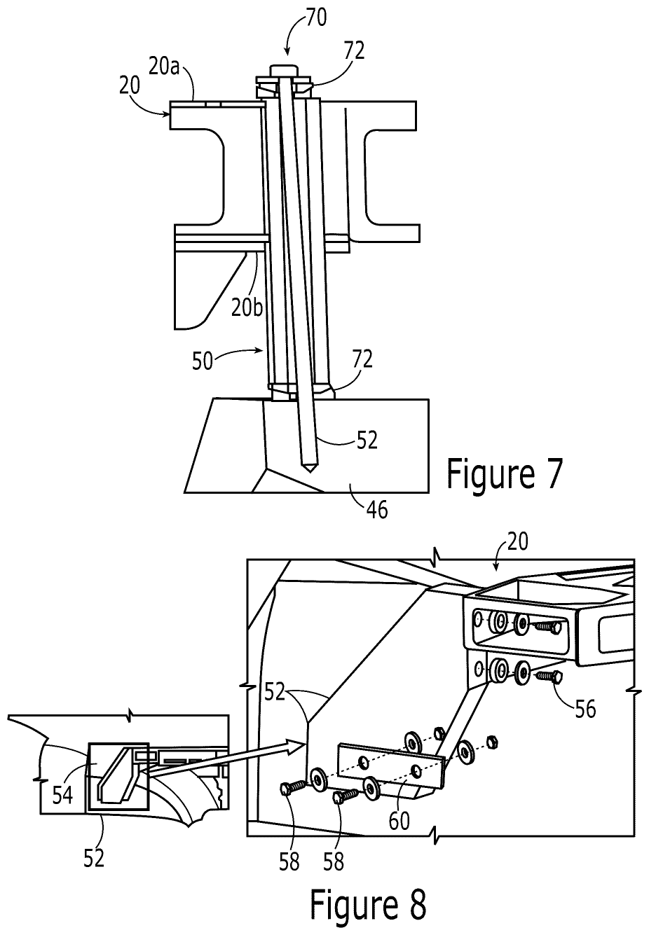

The sensor housing 10 is secured to the base mount 42, such as with a plurality of the connectors 70, such as bolts or other fasteners. Although the sensor housing may be secured to the base mounts in various manners, such, the sensor frame 20 of the illustrated embodiment includes posts 50 that project downwardly from the bottom surface 20b of the frame. The posts may be integral with the remainder of the frame or may be separate from, but positioned adjacent to, the remainder of the frame. The posts sit upon the respective base mount blocks 46 and are aligned with an opening 52, such as a threaded opening, defined by the upper surface of the base mount blocks. As shown in FIG. 7, the connector can be extended through an aperture defined by the frame and, in turn, through the cylindrical post so as to engage the respective base mount 42, such as by being threaded into the opening defined by the respective base mount, thereby securing the frame to the base mounts and, in turn, to the roof 12 of the vehicle 14. As also shown in FIG. 7, the connector can include one or more washers, such as a pair of leveling washers 72, on one or both opposed ends of the posts so as to accommodate surfaces that are not entirely level.

As also shown in FIG. 3, the posts 50 may extend from opposite sides of the frame 20 in order to provide for the secure engagement of the frame with the base mounts 42 and, in turn, with the roof 12 of the vehicle 14. In the illustrated embodiment, the posts that are aligned with the second and third base mounts that are positioned on opposite ends of the sensor frame extend downwardly from the lower surface 20b of the frame at a location proximate the front surface 20c of the frame. However, the center post that is aligned with first base mount extends downwardly from the bottom surface of the frame proximate the rear surface 20d of the frame.

In an example embodiment, the sensor housing 10 includes one or more side mounts 52 configured to mount the frame 20 to a side-facing surface 54 of the vehicle 14. As shown in FIG. 3, the sensor housing of an example embodiment includes first and second side mounts configured to mount the frame to opposite side-facing surfaces of the vehicle. By mounting the frame to the opposite side-facing surfaces of the vehicle, the frame is further secured to the vehicle and any relative movement of the frame with respect to the vehicle is reduced, if not eliminated.

Although the frame 20 may be configured to engage the side mount 52 in various manners, the side mount of one example embodiment is depicted in FIG. 8 and is connected to the frame 20 by one or more fasteners 56, such as one or more bolts. The side mount is also connected to the side-facing surface 54 of the vehicle by one or more fasteners 58, such as by one or more bolts. Although a side mount may be connected to any of various portions of a frame, the side mount of the illustrated embodiment is connected to a respective end of the frame. For example, a first side mount may be connected to left end of the frame and a second side mount may be connected to the right end of the frame. As also shown in FIG. 8, a bracket or other fixture 60 may be affixed or otherwise positioned on the interior of a side facing surface of a vehicle and may define apertures through which the fasteners from the side mount extend, thereby helping to secure the connection between the side mount and the vehicle. The side mount may be configured in various manners. In the illustrated embodiment, however, the side mount is in the form of a bracket with apertures defined to receive the fasteners that connect the side mount to the frame and the fasteners that connect the side mount to the side-facing surface of the vehicle.

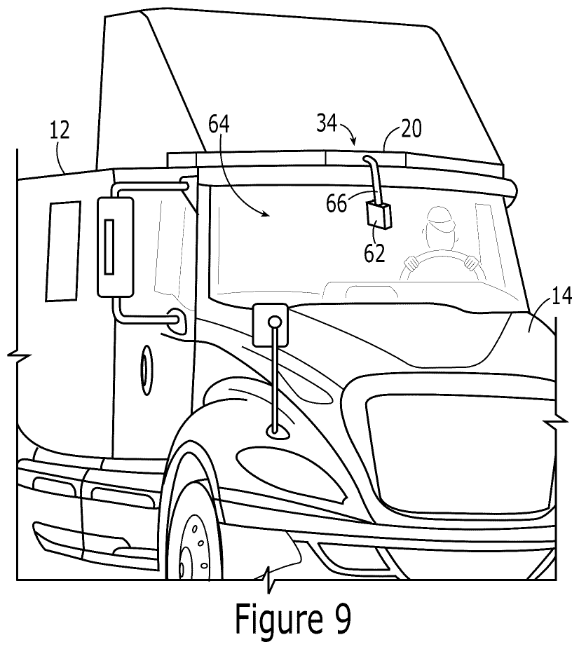

As described above, a sensor housing 10 may include any of a variety of sensors 28 mounted in respective cavities 22 defined by the frame 20. However, the sensor housing of an example embodiment includes at least one sensor, such as a camera 62, mounted external to the frame. In the embodiment depicted in FIG. 9, a camera is mounted to the frame so as to be exterior of the vehicle 14 and oriented such that the field of view of the camera is directed into the cabin 64 of the vehicle, but without obstructing a driver's field of view. In an embodiment, such as the illustrated embodiment, in which the frame includes a medial section 34, the camera that is oriented such that the field of view of the camera is directed into the cabin of the vehicle is mounted to the medial section of the frame. In this regard, a rod or other arm 66 may extend downwardly from the medial section of the frame and the camera may be mounted thereon with the field of view of the camera capturing the cabin of the vehicle or at least an image of the driver within the vehicle. The camera may be adjustably mounted to the rod such that the field of view of the camera may be reoriented, if so desired. Thus, instead of having a field of view that extends forward of the vehicle or to the left or right of the vehicle as do the sensors disposed within the cavities defined by the frame, the field of view of the exterior camera is actually directed rearwardly relative to the direction of travel of the vehicle and, in some embodiments, also downwardly.

Images of the cabin 64 of the vehicle 14 that are captured may be utilized for a variety of reasons. For example, the images of the cabin captured by the exterior camera 62 may be utilized by security applications that provide valuable information in an instance in which the cabin of the vehicle is breached. Additionally, the images captured by the exterior camera may be utilized in conjunction with driving assistance applications, such as in an instance in which the driver is determined in real time or in near real time to be exhibiting symptoms of drowsiness such that a notification may be provided to the driver to park the vehicle until a time the vehicle may be operated more safely. Further, the images captured by the exterior camera may be utilized for training purposes in which the behavior of the driver is monitored and may be subsequently reviewed with the driver in order to encourage behaviors that will improve the performance of the driver.

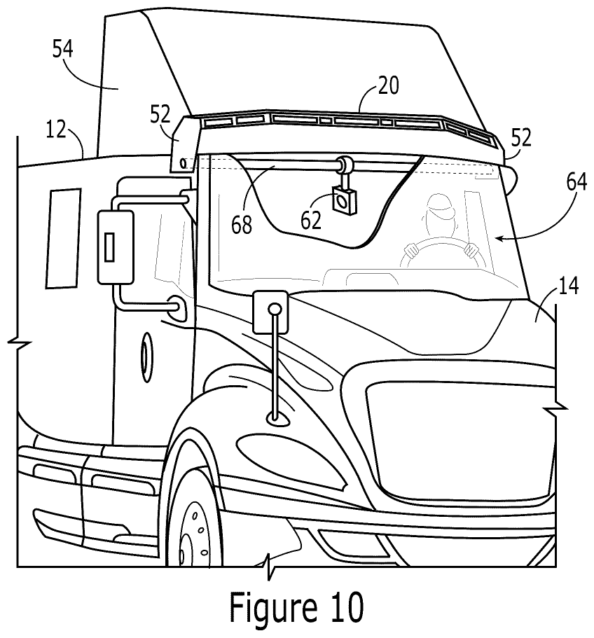

In addition to or instead of providing a camera 62 mounted to the frame 20 that is exterior to the vehicle 14 for capturing an image of the cabin 64 of the vehicle, a sensor housing 10 having first and second side mounts 52 that mount the frame to opposite side-facing surfaces 54 of the vehicle may also include a support rod 68 that extends through the cabin of the vehicle between the first and second side mounts. See FIG. 10. One or more sensors 28 may be mounted upon or otherwise carried by the support rod. For example, a camera may be mounted upon the support rod in order to capture an image of the cabin of the vehicle, such as an image including the driver of the vehicle. As described above, the images of the cabin of the vehicle, such as images of the driver of the vehicle, may be utilized for a variety of reasons including security applications, driver awareness applications, driver training applications, etc.

The frame 20 may be formed of any of a variety of different materials and, as a result, may be fabricated in any of a variety of different manners. For example, the frame may be formed of a metal, such as aluminum, e.g., 5202 aluminum, which is machined to have the desired configuration. Alternatively, the frame may be formed of a composite material, such as formed in a die or cast. In an example embodiment, however, the frame is fabricated in accordance with a tab and slot technique. In this example embodiment in which a frame includes an upper surface 20a, a lower surface 20b and a plurality of internal support stiffeners 26 extending between the upper and lower surfaces, the internal support stiffeners may include a plurality of tabs and the upper and lower surfaces may define a plurality of corresponding slots. The tabs and slots are sized and shaped such that the tabs may be snugly received within corresponding slots. The tabs may then be welded within the corresponding slots such that the resulting frame is a single weldment.

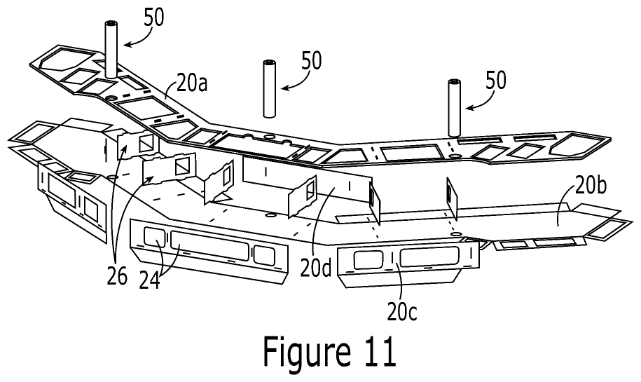

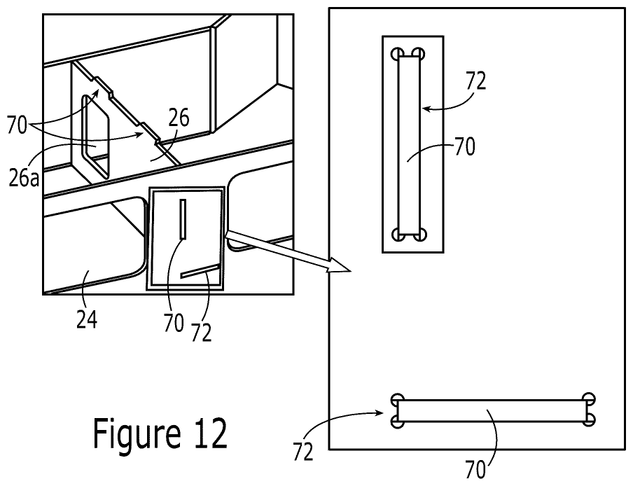

By way of example FIG. 11 depicts an internal support stiffener 26 that extends at least partially between the front surface 20c and the rear surface 20d of the frame 20. The internal support stiffener includes tabs 70 extending forwardly toward the front surface and rearwardly toward the rear surface so as to engage corresponding slots 72 defined by the front and rear surfaces, respectively, of the frame. See FIG. 12. The tabs may then be welded within the corresponding slot of the respective surface of the frame in order to structurally secure the internal support stiffener with the respective surface of the frame. In an example embodiment, the tabs and slots may have a gap of between about 0.2 mm and 1.0 mm between contacting surfaces to reduce noise from friction and the contact of materials and/or may include chamfers so as to facilitate assembly and to avoid stress concentrations.

By utilizing a tab and slot configuration, the assembly of the frame 20 is relatively self-fixturing with the surfaces of the frame and the internal support stiffeners 26 being aligned relative to one another by the engagement of the tabs 70 and corresponding slots 72. Although tabs of an internal support stiffener for engaging front surface 20c and rear surface 20d of a frame are depicted and described above, the internal support stiffeners may include tabs configured to engage corresponding slots defined by the upper surface 20a and the lower surface 20b of the frame in addition to or instead of the tabs that engage the corresponding slots defined by the front and rear surfaces. In this regard, FIG. 12 which depicts the engagement of a tab of an internal support stiffener with a corresponding slot defined by the front surface of the frame also includes a pair of tabs extending upwardly from the internal support stiffener for engaging corresponding slots defined by the upper surface of the frame. Corresponding tabs may also extend from the internal support stiffener rearwardly to engage a corresponding slot defined by the rear surface of the frame and downwardly to engage corresponding slots defined by the lower surface of the frame. As such, the frame of this example embodiment may be assembled and integrated in an efficient manner with improved alignment of the frame and, in turn, of the sensors 28 carried by the frame.

As described above, a sensor housing 10 is provided that is configured to be mounted to the roof 12 of a vehicle 14. The sensor housing securely houses a plurality of sensors 28 secured within a frame 20 that may be structured in a manner consistent with the overall vehicle design while dampening the vibration from the vehicle to the sensors and limiting the aerodynamic impact of the sensor housing. As such, the plurality of sensors housed by the sensor housing can capture information that may be utilized for a variety of purposes including the support of driving operations, such as autonomous driving operations and driver assistance applications. In an example embodiment in which the sensor housing includes a camera 62 mounted to the frame so as to be exterior to the vehicle, the camera may be oriented such that the field of view of the camera is directed into the cab of the vehicle, thereby facilitating use in relating to driver training applications and/or security applications.

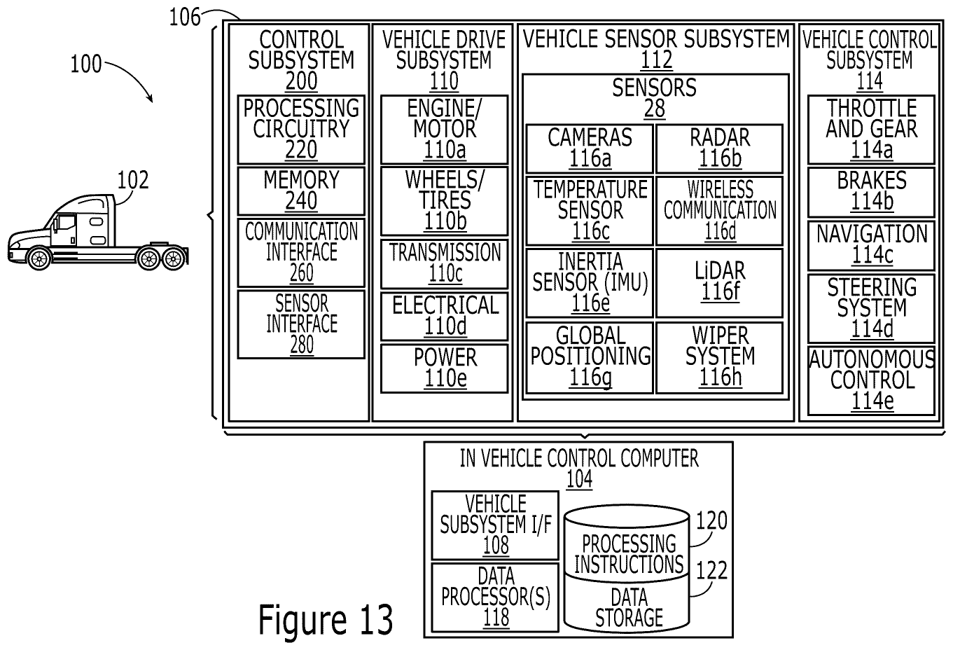

As noted above, the sensors 28 may be configured to communicate with a control subsystem 200 may be carried by or at least in communication with a vehicle 14, such as the autonomous vehicle depicted in FIG. 13 which shows a block diagram of an example vehicle ecosystem 100 in which autonomous driving operations can be determined. Although the control subsystem may be embodied in various manners, the control subsystem of an example embodiment may include processing circuitry 220, memory 240, a communication interface 260 and a sensor interface 280. The autonomous vehicle 102 may be a semi-trailer truck. The vehicle ecosystem includes several systems and components that can generate and/or deliver one or more sources of information/data and related services to the in-vehicle control computer 104 that may be located in an autonomous vehicle. The in-vehicle control computer can be in data communication with a plurality of vehicle subsystems 106, all of which can be resident in the autonomous vehicle. A vehicle subsystem interface 108 is provided to facilitate data communication between the in-vehicle control computer and the plurality of vehicle subsystems. In some embodiments, the vehicle subsystem interface can include a controller area network (CAN) controller to communicate with devices in the vehicle subsystems.

The autonomous vehicle 102 may include various vehicle subsystems that support of the operation of autonomous vehicle. The vehicle subsystems may include the control subsystem 200, a vehicle drive subsystem 110, a vehicle sensor subsystem 112, and/or a vehicle control subsystem 114. The components or devices of the vehicle drive subsystem, the vehicle sensor subsystem, and the vehicle control subsystem shown in FIG. 13 are examples. The vehicle drive subsystem may include components operable to provide powered motion for the autonomous vehicle. In an example embodiment, the vehicle drive subsystem may include an engine/motor 110a, wheels/tires 110b, a transmission 110c, an electrical subsystem 110d, and a power source 110e.

The vehicle sensor subsystem 112 may include a number of sensors 28 configured to sense information about an environment or condition of the autonomous vehicle 102. The vehicle sensor subsystem may include one or more cameras 116a or image capture devices, a radar unit 116b, one or more temperature sensors 116c, a wireless communication unit 116d (e.g., a cellular communication transceiver), an inertial measurement unit (IMU) 116e, a laser range finder/LiDAR unit 116f, a Global Positioning System (GPS) transceiver 116g, and/or a wiper control system 116h. The vehicle sensor subsystem may also include sensors configured to monitor internal systems of the autonomous vehicle (e.g., an 02 monitor, a fuel gauge, an engine oil temperature, etc.).

The IMU 116e may include any combination of sensors (e.g., accelerometers and gyroscopes) configured to sense position and orientation changes of the autonomous vehicle 102 based on inertial acceleration. The GPS transceiver 116g may be any sensor configured to estimate a geographic location of the autonomous vehicle. For this purpose, the GPS transceiver may include a receiver/transmitter operable to provide information regarding the position of the autonomous vehicle with respect to the Earth. The radar unit 116b may represent a system that utilizes radio signals to sense objects within the local environment of the autonomous vehicle. In some embodiments, in addition to sensing the objects, the radar unit may additionally be configured to sense the speed and the heading of the objects proximate to the autonomous vehicle. The laser range finder or LiDAR unit 116f may be any sensor configured to sense objects in the environment in which the autonomous vehicle is located using lasers. The cameras 116a may include one or more devices configured to capture a plurality of images of the environment of the autonomous vehicle. The cameras may be still image cameras or motion video cameras.

The vehicle control subsystem 114 may be configured to control the operation of the autonomous vehicle 102 and its components. Accordingly, the vehicle control subsystem may include various elements such as a throttle and gear 114a, a brake unit 114b, a navigation unit 114c, a steering system 114d, and/or an autonomous control unit 114e. The throttle may be configured to control, for instance, the operating speed of the engine and, in turn, control the speed of the autonomous vehicle. The gear may be configured to control the gear selection of the transmission. The brake unit can include any combination of mechanisms configured to decelerate the autonomous vehicle. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle. The navigation unit may additionally be configured to update the driving path dynamically while the autonomous vehicle is in operation. In some embodiments, the navigation unit may be configured to incorporate data from the GPS transceiver 116g and one or more predetermined maps so as to determine the driving path for the autonomous vehicle. The steering system may represent any combination of mechanisms that may be operable to adjust the heading of autonomous vehicle in an autonomous mode or in a driver-controlled mode.

The autonomous control unit 114e may represent a control system configured to identify, evaluate, and avoid or otherwise negotiate potential obstacles or obstructions in the environment of the autonomous vehicle 102. In general, the autonomous control unit may be configured to control the autonomous vehicle for operation without a driver or to provide driver assistance in controlling the autonomous vehicle. In some embodiments, the autonomous control unit may be configured to incorporate data from the GPS transceiver 116g, the radar 116b, the LiDAR unit 116f, the cameras 116a, and/or other vehicle subsystems to determine the driving path or trajectory for the autonomous vehicle.

Many or all of the functions of the autonomous vehicle 102 can be controlled by the in-vehicle control computer 104. The in-vehicle control computer may include at least one data processor 118 (which can include at least one microprocessor) that executes processing instructions 120 stored in a non-transitory computer readable medium, such as the data storage device 122 or memory. The in-vehicle control computer may also represent a plurality of computing devices that may serve to control individual components or subsystems of the autonomous vehicle in a distributed fashion. In some embodiments, the data storage device may contain processing instructions (e.g., program logic) executable by the data processor to perform various methods and/or functions of the autonomous vehicle.

The data storage device 122 may contain additional instructions as well, including instructions to transmit data to, receive data from, interact with, or control one or more of the vehicle drive subsystem 110, the vehicle sensor subsystem 112, and the vehicle control subsystem 114. The in-vehicle control computer 104 can be configured to include a data processor 118 and a data storage device 122. The in-vehicle control computer may control the function of the autonomous vehicle 102 based on inputs received from various vehicle subsystems (e.g., the vehicle drive subsystem, the vehicle sensor subsystem, and the vehicle control subsystem).

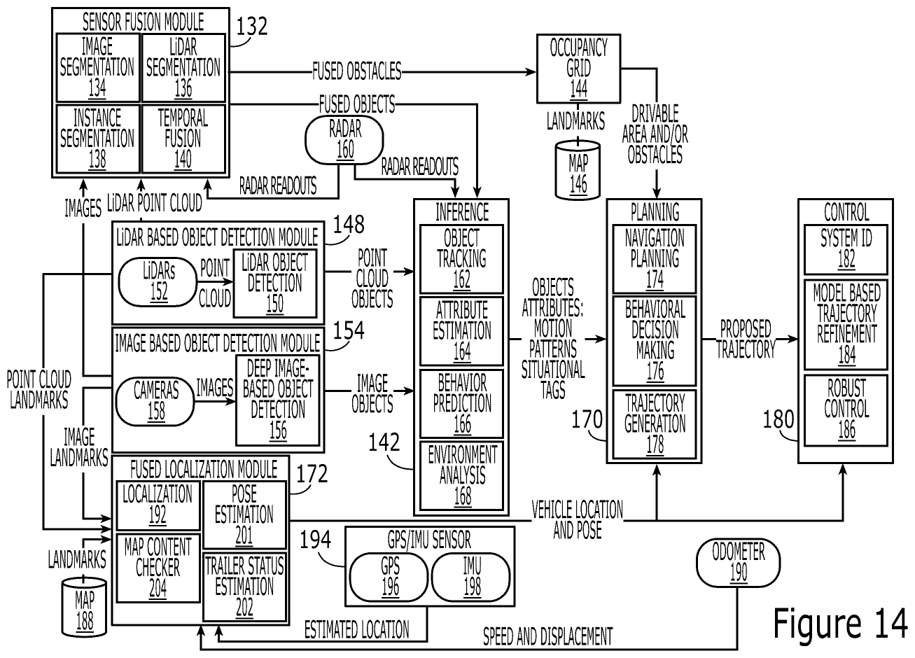

FIG. 14 shows an exemplary system 130 for providing precise autonomous driving operations. The system includes several modules that can operate in the in-vehicle control computer 104, as described in conjunction with FIG. 13. The in-vehicle control computer includes a sensor fusion module 132 shown in the top left corner of FIG. 14, where the sensor fusion module may perform at least four image or signal processing operations. The sensor fusion module can obtain images from cameras located on an autonomous vehicle 102 to perform image segmentation 134 to detect the presence of moving objects (e.g., other vehicles, pedestrians, etc.,) and/or static obstacles (e.g., stop sign, speed bump, terrain, etc.,) located around the autonomous vehicle. The sensor fusion module 132 can obtain LiDAR point cloud data item from LiDAR sensors located on the autonomous vehicle to perform LiDAR segmentation 136 to detect the presence of objects and/or obstacles located around the autonomous vehicle.

The sensor fusion module 132 can perform instance segmentation 138 on image and/or point cloud data item to identify an outline (e.g., boxes) around the objects and/or obstacles located around the autonomous vehicle 102. The sensor fusion module can perform temporal fusion 140 where objects and/or obstacles from one image and/or one frame of point cloud data item are correlated with or associated with objects and/or obstacles from one or more images or frames subsequently received in time.

The sensor fusion module 132 can fuse the objects and/or obstacles from vehicle sensors, such as the images obtained from the camera and/or point cloud data item obtained from the LiDAR sensors. For example, the sensor fusion module may determine based on a location of two cameras that an image from one of the cameras comprising one half of a vehicle located in front of the autonomous vehicle 102 is the same as the vehicle located captured by another camera. The sensor fusion module sends the fused object information to the interference module 142 and the fused obstacle information to the occupancy grid module 144. The in-vehicle control computer includes the occupancy grid module can retrieve landmarks from a map database 146 stored in the in-vehicle control computer. The occupancy grid module can determine drivable areas and/or obstacles from the fused obstacles obtained from the sensor fusion module and the landmarks stored in the map database. For example, the occupancy grid module can determine that a drivable area may include a speed bump obstacle.

Below the sensor fusion module 132, the in-vehicle control computer 104 includes a LiDAR based object detection module 148 that can perform object detection 150 based on point cloud data item obtained from the LiDAR sensors 152 located on the autonomous vehicle 10. The object detection technique can provide a location (e.g., in 3D world coordinates) of objects from the point cloud data item. Below the LiDAR based object detection module, the in-vehicle control computer includes an image-based object detection module 154 that can perform object detection 156 based on images obtained from cameras 158 located on the autonomous vehicle. The object detection technique can employ a deep machine learning technique to provide a location (e.g., in 3D world coordinates) of objects from the image provided by the camera.

The radar 160 on the autonomous vehicle 10 can scan an area in front of the autonomous vehicle or an area towards which the autonomous vehicle is driven. The radar data is sent to the sensor fusion module 132 that can use the radar data to correlate the objects and/or obstacles detected by the radar with the objects and/or obstacles detected from both the LiDAR point cloud data item and the camera image. The radar data is also sent to the inference module 142 that can perform data processing on the radar data to track objects 162 as further described below.

The in-vehicle control computer 104 includes an interference module 142 that receives the locations of the objects from the point cloud and the objects from the image, and the fused objects from the sensor fusion module 132. The interference module also receives the radar data with which the interference module can track objects 162 from one point cloud data item and one image obtained at one time instance to another (or the next) point cloud data item and another image obtained at another subsequent time instance.

The interference module 142 may perform object attribute estimation 164 to estimate one or more attributes of an object detected in an image or point cloud data item. The one or more attributes of the object may include a type of object (e.g., pedestrian, car, or truck, etc.). The interference module may perform behavior prediction 166 to estimate or predict motion pattern of an object detected in an image and/or a point cloud. The behavior prediction can be performed to detect a location of an object in a set of images received at different points in time (e.g., sequential images) or in a set of point cloud data item received at different points in time (e.g., sequential point cloud data items). In some embodiments the behavior prediction can be performed for each image received from a camera and/or each point cloud data item received from the LiDAR sensor. In some embodiments, the interference module can be performed to reduce computational load by performing behavior prediction on every other or after every pre-determined number of images received from a camera or point cloud data item received from the LiDAR sensor (e.g., after every two images or after every three point cloud data items).

The behavior prediction 166 feature may determine the speed and direction of the objects that surround the autonomous vehicle 10 from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 142 may assign motion pattern situational tags to the objects (e.g., “located at coordinates (x,y),” “stopped,” “driving at 50 mph,” “speeding up” or “slowing down”). The situation tags can describe the motion pattern of the object. The interference module sends the one or more object attributes (e.g., types of the objects) and motion pattern situational tags to the planning module 170. The interference module may perform an environment analysis 168 using any information acquired by system 130 and any number and combination of its components.

The in-vehicle control computer 104 includes the planning module 170 that receives the object attributes and motion pattern situational tags from the interference module 142, the drivable area and/or obstacles, and the vehicle location and pose information from the fused localization module 172 (further described below).

The planning module 170 can perform navigation planning 174 to determine a set of trajectories on which the autonomous vehicle 10 can be driven. The set of trajectories can be determined based on the drivable area information, the one or more object attributes of objects, the motion pattern situational tags of the objects, location of the obstacles, and the drivable area information. In some embodiments, the navigation planning may include determining an area next to the road where the autonomous vehicle can be safely parked in case of emergencies. The planning module may include behavioral decision making 176 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module performs trajectory generation 178 and selects a trajectory from the set of trajectories determined by the navigation planning operation. The selected trajectory information is sent by the planning module to the control module 180.

The in-vehicle control computer 104 includes a control module 180 that receives the proposed trajectory from the planning module 170 and the autonomous vehicle location and pose from the fused localization module 172. The control module includes a system identifier 182. The control module can perform a model-based trajectory refinement 184 to refine the proposed trajectory. For example, the control module can apply a filtering (e.g., Kalman filter) to make the proposed trajectory data smooth and/or to minimize noise. The control module may perform the robust control 186 by determining, based on the refined proposed trajectory information and current location and/or pose of the autonomous vehicle, an amount of brake pressure to apply, a steering angle, a throttle amount to control the speed of the vehicle, and/or a transmission gear. The control module can send the determined brake pressure, steering angle, throttle amount, and/or transmission gear to one or more devices in the autonomous vehicle to control and facilitate precise driving operations of the autonomous vehicle 10.

The deep image-based object detection 156 performed by the image-based object detection module 154 can also be used detect landmarks (e.g., stop signs, speed bumps, etc.,) on the road. The in-vehicle control computer 104 includes a fused localization module 172 that obtains landmarks detected from images, the landmarks obtained from a map database 188 stored on the in-vehicle control computer, the landmarks detected from the point cloud data item by the LiDAR based object detection module 148, the speed and displacement from the odometer sensor 190 and the estimated location of the autonomous vehicle from the GPS/IMU sensor 194 (i.e., GPS sensor 196 and IMU sensor 198) located on or in the autonomous vehicle 10. Based on this information, the fused localization module can perform a localization operation 192 to determine a location of the autonomous vehicle, which can be sent to the planning module 170 and the control module 180.

The fused localization module 172 can estimate pose 201 of the autonomous vehicle 10 based on the GPS and/or IMU sensors 194. The pose of the autonomous vehicle can be sent to the planning module 170 and the control module 180. The fused localization module can also estimate status (e.g., location, possible angle of movement) of the trailer unit 202 based on, for example, the information provided by the IMU sensor 198 (e.g., angular rate and/or linear velocity). The fused localization module may also check the map content 204.

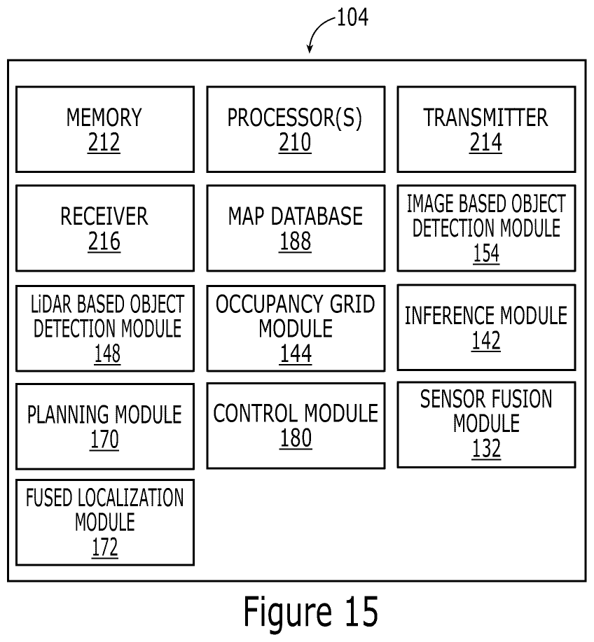

FIG. 15 shows an exemplary block diagram of an in-vehicle control computer 104 included in an autonomous vehicle 102. The in-vehicle control computer includes processing circuitry, such as at least one processor 210 and a memory 212 having instructions stored thereupon. The instructions upon execution by the processor configure the in-vehicle control computer and/or the various modules of the in-vehicle control computer to perform the operations described above. The transmitter 214 transmits or sends information or data to one or more devices in the autonomous vehicle. For example, a transmitter can send an instruction to one or more motors of the steering wheel to steer the autonomous vehicle. The receiver 216 receives information or data transmitted or sent by one or more devices. For example, the receiver receives a status of the current speed from the odometer sensor or the current transmission gear from the transmission. The transmitter and receiver are also configured to communicate with the control subsystem 200 described above.

Clause 1. A sensor housing configured to be mounted to a roof of a vehicle, the sensor housing comprising: a frame defining a plurality of cavities and defining a plurality of windows opening into respective cavities of the plurality of cavities; and a plurality of sensors, wherein at least some of the sensors are disposed within the respective cavities defined by the frame, and wherein the sensors disposed within the respective cavities defined by the frame are oriented relative to the frame such that fields of view of the sensors that are disposed within the respective cavities defined by the frame are directed through the windows that open into the respective cavities, wherein at least one of the plurality of sensors comprises a camera mounted to the frame so as to be exterior to the vehicle and oriented such that a field of view of the camera is directed into a cabin of the vehicle.

Clause 2. A sensor housing according to Clause 1 wherein the frame comprises a medial section and first and second side sections extending both outwardly and rearwardly from opposite sides of the medial section.

Clause 3. A sensor housing according to Clause 2 wherein the camera that is oriented such that the field of view of the camera is directed into the cabin of the vehicle is mounted to the medial section of the frame.

Clause 4. A sensor housing according to Clause 1 wherein the frame further defines a channel extending between the plurality of cavities and configured to house at least one of electrical wiring for the plurality of sensors or plumbing for directing cleaning fluid to the plurality of sensors.

Clause 5. A sensor housing according to Clause 1 wherein the frame further defines one or more rear windows opening through a rear surface of the frame and into respective cavities of the plurality of cavities.

Clause 6. A sensor housing according to Clause 1 further comprising one or more base mounts configured to mount the frame to the roof of the vehicle, wherein a respective base mount of the one or more base mounts comprises a resilient gasket disposed on the roof of the vehicle and a base mount block positioned upon the resilient gasket and connected to the roof of the vehicle.

Clause 7. A sensor housing according to Clause 1 wherein the frame is comprised of a composite material.

Clause 8. A sensor housing according to Clause 1 wherein the frame is configured to be disposed within a wind deflector on the roof of the vehicle, and wherein the plurality of windows defined by the frame are configured to be aligned with respective openings defined by the wind deflector.

Clause 9. A sensor housing according to Clause 1 wherein the plurality of sensors are in communication with a compute unit that is disposed within a wind deflector on the roof of the vehicle.

Clause 10. A sensor housing configured to be mounted to a roof of a vehicle, the sensor housing comprising: a frame defining a plurality of cavities and defining a plurality of windows opening into respective cavities of the plurality of cavities, wherein the plurality of cavities are configured to house corresponding sensors; and one or more base mounts configured to mount the frame to the roof of the vehicle; and one or more side mounts configured to mount the frame to a side-facing surface of the vehicle.

Clause 11. A sensor housing according to Clause 10 wherein the one or more side mounts comprise first and second side mounts configured to mount the frame to opposite side-facing surfaces of the vehicle.

Clause 12. A sensor housing according to Clause 11 further comprising a support rod extending through a cabin of the vehicle and between the first and second side mounts.

Clause 13. A sensor housing according to Clause 12 further comprising a camera mounted to the support rod so as to have a field of view directed into the cabin of the vehicle.

Clause 14. A sensor housing according to Clause 10 wherein the frame comprises a medial section and first and second side sections extending both outwardly and rearwardly from opposite sides of the medial section.

Clause 15. A sensor housing according to Clause 10 wherein the frame further defines a channel extending between the plurality of cavities and configured to house at least one of electrical wiring for the sensors or plumbing for directing cleaning fluid to the sensors.

Clause 16. A sensor housing according to Clause 10 wherein the frame further defines one or more rear windows opening through a rear surface of the frame and into respective cavities of the plurality of cavities.

Clause 17. A sensor housing according to Clause 10 wherein a respective base mount of the one or more base mounts comprises a resilient gasket disposed on the roof of the vehicle and a base mount block positioned upon the resilient gasket and connected to the roof of the vehicle.

Clause 18. A sensor housing according to Clause 10 wherein the frame is comprised of a composite material.

Clause 19. A sensor housing according to Clause 10 wherein the frame is configured to be disposed within a wind deflector on the roof of the vehicle, and wherein the plurality of windows defined by the frame are configured to be aligned with respective openings defined by the wind deflector.

Clause 20. A sensor housing according to Clause 10 wherein the plurality of sensors are in communication with a compute unit that is disposed within a wind deflector on the roof of the vehicle.

Clause 21. A sensor housing configured to be mounted to a roof of a vehicle, the sensor housing comprising: a frame defining a plurality of cavities and defining a plurality of windows opening into respective cavities of the plurality of cavities, wherein the plurality of cavities are configured to house corresponding sensors, wherein the frame comprises upper and lower surfaces and a plurality of internal support stiffeners extending between the upper and lower surfaces, wherein the internal support stiffeners comprise a plurality of tabs and the upper and lower surfaces define a plurality of corresponding slots for receiving and being welded to respective tabs such that the is a single weldment.

Clause 22. A sensor housing according to Clause 21 wherein the frame comprises a medial section and first and second side sections extending both outwardly and rearwardly from opposite sides of the medial section.

Clause 23. A sensor housing according to Clause 21 wherein the frame further defines a channel extending between the plurality of cavities and configured to house at least one of electrical wiring for the sensors or plumbing for directing cleaning fluid to the sensors.

Clause 24. A sensor housing according to Clause 21 wherein the frame further defines one or more rear windows opening through a rear surface of the frame and into respective cavities of the plurality of cavities.

Clause 25. A sensor housing according to Clause 21 further comprising one or more base mounts configured to mount the frame to the roof of the vehicle, wherein a respective base mount of the one or more base mounts comprises a resilient gasket disposed on the roof of the vehicle and a base mount block positioned upon the resilient gasket and connected to the roof of the vehicle.

Clause 26. A sensor housing according to Clause 21 wherein the frame is configured to be disposed within a wind deflector on the roof of the vehicle, and wherein the plurality of windows defined by the frame are configured to be aligned with respective openings defined by the wind deflector.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A sensor housing configured to be mounted to a roof of a vehicle, the sensor housing comprising:
a frame defining a plurality of cavities and defining a plurality of windows opening into respective cavities of the plurality of cavities; and
a plurality of sensors, wherein at least some of the sensors are disposed within the respective cavities defined by the frame, and wherein the sensors disposed within the respective cavities defined by the frame are oriented relative to the frame such that fields of view of the sensors that are disposed within the respective cavities defined by the frame are directed through the windows that open into the respective cavities,
wherein at least one of the plurality of sensors comprises a camera mounted to the frame so as to be exterior to the vehicle and oriented such that a field of view of the camera is directed into a cabin of the vehicle.

2. The sensor housing according to claim 1 wherein the frame comprises a medial section and first and second side sections extending both outwardly and rearwardly from opposite sides of the medial section.

3. The sensor housing according to claim 2 wherein the camera that is oriented such that the field of view of the camera is directed into the cabin of the vehicle is mounted to the medial section of the frame.

4. The sensor housing according to claim 1 wherein the frame further defines a channel extending between the plurality of cavities and configured to house at least one of electrical wiring for the plurality of sensors or plumbing for directing cleaning fluid to the plurality of sensors.

5. The sensor housing according to claim 1 wherein the frame further defines one or more rear windows opening through a rear surface of the frame and into respective cavities of the plurality of cavities.

6. The sensor housing according to claim 1 further comprising one or more base mounts configured to mount the frame to the roof of the vehicle, wherein a respective base mount of the one or more base mounts comprises a resilient gasket disposed on the roof of the vehicle and a base mount block positioned upon the resilient gasket and connected to the roof of the vehicle.

7. The sensor housing according to claim 1 wherein the frame is comprised of a composite material.

8. The sensor housing according to claim 1 wherein the frame is configured to be disposed within a wind deflector on the roof of the vehicle, and wherein the plurality of windows defined by the frame are configured to be aligned with respective openings defined by the wind deflector.

9. The sensor housing according to claim 1 wherein the plurality of sensors are in communication with a compute unit that is disposed within a wind deflector on the roof of the vehicle.

10. A sensor housing configured to be mounted to a roof of a vehicle, the sensor housing comprising:
a frame defining a plurality of cavities and defining a plurality of windows opening into respective cavities of the plurality of cavities, wherein the plurality of cavities are configured to house corresponding sensors; and
one or more base mounts configured to mount the frame to the roof of the vehicle; and
one or more side mounts configured to mount the frame to a side-facing surface of the vehicle.

11. The sensor housing according to claim 10 wherein the one or more side mounts comprise first and second side mounts configured to mount the frame to opposite side-facing surfaces of the vehicle.

12. The sensor housing according to claim 11 further comprising a support rod extending through a cabin of the vehicle and between the first and second side mounts.

13. The sensor housing according to claim 12 further comprising a camera mounted to the support rod so as to have a field of view directed into the cabin of the vehicle.

14. The sensor housing according to claim 10 wherein the frame comprises a medial section and first and second side sections extending both outwardly and rearwardly from opposite sides of the medial section.

15. The sensor housing according to claim 10 wherein the frame further defines a channel extending between the plurality of cavities and configured to house at least one of electrical wiring for the sensors or plumbing for directing cleaning fluid to the sensors.

16. The sensor housing according to claim 10 wherein the frame further defines one or more rear windows opening through a rear surface of the frame and into respective cavities of the plurality of cavities.

17. The sensor housing according to claim 10 wherein a respective base mount of the one or more base mounts comprises a resilient gasket disposed on the roof of the vehicle and a base mount block positioned upon the resilient gasket and connected to the roof of the vehicle.

18. The sensor housing according to claim 10 wherein the frame is comprised of a composite material.

19. The sensor housing according to claim 10 wherein the frame is configured to be disposed within a wind deflector on the roof of the vehicle, and wherein the plurality of windows defined by the frame are configured to be aligned with respective openings defined by the wind deflector.

20. The sensor housing according to claim 10 wherein the plurality of sensors are in communication with a compute unit that is disposed within a wind deflector on the roof of the vehicle.
